(19) United States
(12) Patent Application Publication
(10) Pub. No.: US 2007/0011717 A1
(43) Pub. Date: Jan. 11, 2007

(54) Distribution of interactive information content within a plurality of disparate distribution networks

(76) Inventors: Gary M. Lauder, Atherton, CA (US); Mitchell S. Askenas, San Jose, CA (US); Gregory Eugene Brown, Fremont, CA (US)

Correspondence Address: BROMBERG & SUNSTEIN LLP, 125 SUMMER STREET, BOSTON, MA, 02110-1618, US

(21) Appl. No.: 11/234,872

(22) Filed: Sep. 23, 2005

Related U.S. Application Data
(63) Continuation-in-part of application No. 11/176,953, filed on Jul. 6, 2005, now abandoned.

(51) Int. Cl. H04N 7/16; H04N 7/173

(52) U.S. Cl. 725/135; 725/117; 725/116; 725/146; 725/147

(57) ABSTRACT

An interactive information platform and method for distribution of interactive information content is shared by a plurality of disparate distribution networks. The interactive information platform includes a plurality of assignable sessions processors that render and encode the information content into a format capable of being decoded by a digital decoder associated with a television on any of the disparate distribution networks. The interactive information platform also includes an operation manager that receives requests for interactive television content from one or more digital decoders in one of a plurality of disparate distribution networks such as a cable television network, a telephone network, or a wireless network. The operation manager establishes an interactive session with the requesting digital decoder and assigns one of the sessions processors to the interactive session.

### PRIORITY

The present application is a continuation-in-part of patent application Ser. No. 11/176,953 filed on Jul. 6, 2005 entitled “Distribution of Interactive Information Content within a Plurality of Disparate Distribution Networks,” which is incorporated herein by reference in its entirety.

### TECHNICAL FIELD AND BACKGROUND ART

The present invention relates to television distribution networks and more specifically to providing interactive content to a plurality of disparate distribution networks having different distribution formats or different transport mediums.

In a cable network, it is known to allow a set-top box to make a request to a cable headend for the establishment of an interactive session in order to receive and display interactive cable television content on the television associated with the set-top box. For example, an interactive television system for use on a cable distribution network is disclosed in U.S. Pat. No. 6,305,020. As applied to digital set-top boxes, after an interactive session is established, interactive content is formatted into an MPEG format that is decodable by the set-top box. The MPEG video and audio stream is modulated for transmission on the cable. For example, multiple MPEG video and audio streams, each associated with a separate interactive session may be quadrature amplitude modulated (QAM) and transmitted over the same cable connection to the requesting cable set-top boxes.

Other systems have been described for use in distributing interactive television over a telephone system. For example, U.S. Pat. No. 5,361,091 discloses an interactive television system operative over a fiber optic telephone system and separately describes a system operative over a cable system.

### SUMMARY OF THE INVENTION

In accordance with embodiments of the invention, an interactive television system can be connected to disparate television distribution networks for providing interactivity to users who receive television through different distribution formats. For example, the interactive television system can be used with any two of a cable distribution network, a telephone system based distribution network or a wireless telephone distribution network.

In accordance with an embodiment of the invention, a plurality of assignable interactive processes provide interactive television information content in response to signals from television users. Television information content from the interactive processes is carried on a communication link in a given transport protocol. Each of a plurality of distribution networks is in communication with the communication link to distribute the interactive television information content through the respective distribution network to the user interacting with that content. The distribution equipment associated with a given distribution network is connected to the communication link. A cable television network may be connected to a communication link through a multiplexor, multiplexing information content onto a cable television signal. The signal may be a rf carrier signal and the operations performed by the multiplexor may include quadrature amplitude multiplexing. On a telephone system, the distribution equipment may include a DSL multiplexor or a router for directing television information content to its respective television user over an IP network.

In accordance with embodiments of the present invention, an operation manager processes requests for interactive service and assigns an interactive process to the user. Upstream communications from the user to the interactive television system may come through the television distribution network of the user or through an alternative communication pathway. For example, in a two way cable system, users can send signals up through the cable network. Alternatively, a user may be connected to a telephone system to send upstream signals to the interactive system, even though the downstream television signals come through the cable system. Upstream communications can be transmitted by the user through a digital decoder such as a set-top box equipped with two-way communication or an alternative controller hooked into a telephone system.

Interactive processes may provide access to a variety of interactive television services. These may include movies, games, internet, wall gardens, catalogs and any other variety of interactive television services. Content servers may provide movies or other content to an interactive process so that an individual user can interact with commands such as play, pause, rewind, fast forward etc. A game may be loaded from a content server to an interactive process so that the user can interact with the process to enjoy a game on the user's television set. The interactive process may need to render the television information content into a format for television viewing. After rendering, a transcoding process may be required to put the information content into a format that is compatible with the digital decoder that has requested the interactive information content. Transcoding may include compressing the information content data. The digital decoder would include a decoder that could decode the compressed information content. In certain embodiments, the information content would be compressed using an MPEG compression scheme.

### BRIEF DESCRIPTION OF THE DRAWINGS

The foregoing features of the invention will be more readily understood by reference to the following detailed description, taken with reference to the accompanying drawings, in which:

FIG. 1 is an environment showing a plurality of distribution networks receiving interactive television content from an interactive information platform;

FIG. 2 is a more detailed representation of the headend; and

FIG. 3 is a flow chart of a method for providing interactive information content to a requesting user on one of a plurality of disparate distribution networks.

### DETAILED DESCRIPTION OF SPECIFIC EMBODIMENTS

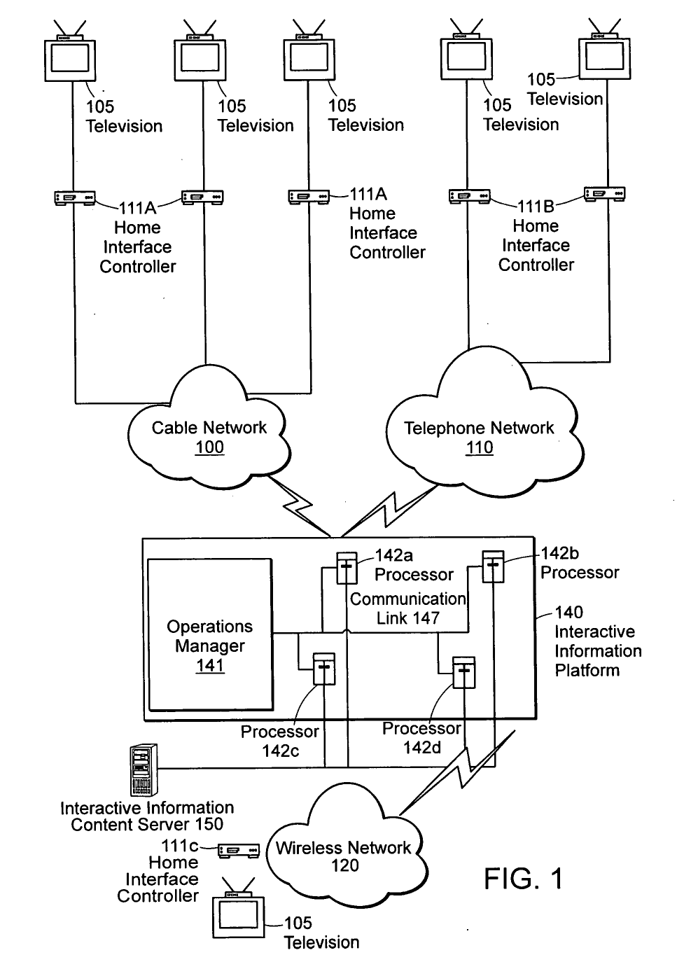

FIG. 1 is an environment showing a plurality of disparate television distribution networks 100, 110, 120 coupled to a single interactive information platform 140 for interactive television content. The distribution networks are disparate in that one is a cable television network (analog or digital) 100, one is a wireless network 120 and one is a telephone network 110. Television distribution networks may be disparate with regard to the physical characteristics of the transport medium or the character of the carrier or transport signals of the downstream television distribution. For example, cable television is a trunk and branches physical layout, whereas telephone systems provide a switched network of point-to-point connections. Other disparities may relate to the method of signal transport. The telephone distribution network may be an IP television network, such that it supports digital subscriber line (DSL) transmissions. A cable system may transmit information using rf carrier signals. Other disparate cable systems may transmit digital data using Data Over Cable Service Interface Specifications (DOCSIS). Disparate television distribution networks may differ as to transport medium, transport signals or both.

In certain embodiments, the distribution system may be a mixed system. For example, a telephony system may be employed for transmission of information in an upstream direction (from the user to the interactive information platform) whereas a cable distribution system may be employed in the downstream direction. The interactive information platform 140 may be located at a cable television headend, a telephony central office, or at a remote location separate from the central transmission point of the distribution networks.

Components of the interactive information platform 140 may be localized at one location or distributed among a plurality of locations, since the components of the interactive information platform form a logical network and communicate via standard protocols, such as IP (Internet Protocol). This logical network may be referred to as a communication link 147. The communication link 147 may also include a physical component, such as an Ethernet connection, wherein some or all of the components are physically on the same network. The communication link 147 serves disparate networks wherein some of the disparate networks use the addressing scheme of the communication link to route information content to a requesting device within the network, such as a set-top box. An example of such a distribution network is an IP telephony network. Other disparate networks are served by the communications link wherein the addressing scheme used by the communications link is either removed and substituted or supplemented and this different addressing scheme is used to address information content to the requesting device. An example of such a distribution network is a cable television network.

Each distribution network communicates television signals for display on television sets. The term “television” as used herein shall refer to devices that are capable of displaying signals (for example NTSC, PAL, YUV, RGB, composite etc.) and may or may not include a tuner. The television has an associated digital decoder. The digital decoders may handle the decoding and tuning functions. If a television does not include an integral digital decoder, a digital decoder 111A, 111B, 111C will be required with a television set. In the embodiments shown, the digital decoders also handle the upstream data communications. The digital decoders transmit requests for establishing an interactive session and request interactive information content through their respective distribution networks. Examples of a digital decoders includes a cable set-top box, such as, Motorola's DCT 2000, a cable card, and an IP set-top box, such as the AmiNet110 produced by Amino Communications Ltd which couples to the telephony distribution network through an Ethernet port. Each distribution network requires digital decoders 111A, 111B, 111C that are compatible with the transmission format of the respective distribution network. For example, a cable television system may multiplex multiple digital information signals into a single data stream and then modulate the data stream to be transmitted over the cable using quadrature amplitude modulation (QAM) and therefore, the digital decoder 111A would include a QAM demodulator. The digital decoder further determines which of the information signals should be decoded and provided to the television 105. Similarly, if a telephony distribution network 110 is used and the telephony network supports the IP transfer protocol, the home digital decoder 111B in this distribution network recognizes the one or more IP addresses associated with itself and will decode information content that is associated with those IP addresses. Other transmission mediums may be employed with the distribution networks including HFC (Hybrid Fiber/Coax), FTTC (fiber to the curb), ATM (asynchronous transfer mode), and wireless.

Each of the digital decoders 111A-C preferably decodes at least one common media format. In one embodiment, the common media format is a variant of the MPEG (Motion Pictures Expert Group) format (e.g. MPEG-2, MPEG-4), but may be another format (e.g. wavelet compression format, Windows® media player format etc.). Thus, regardless of the transmission format each digital decoder decodes a common media format for the interactive information content that is provided by the interactive information platform. By having a single media format, the processing requirements of the interactive information platform are reduced, since the processors need to be capable of only performing one type of encoding scheme, and thus, may be optimized for that encoding scheme.

Although more complex, other embodiments may be envisioned in which the digital decoders of the disparate networks do not share a common decoder. The interactive information platform would need to support a plurality of encoders so that the interactive information content may be encoded into a media format that is compatible with the digital decoder of any one of the distribution networks.

When a user requests interactive information content, the user employs a user input, such as a remote control or a keyboard that signals to the digital decoder 111A-C to begin an interactive session. If the set-top is not configured for two-way communication, alternative systems may use a telephone, land-based or wireless, to send requests up to the interactive information platform. The request for interactive service might be a designated input or button. On the other hand, the request may simply be a channel number which the system has assigned to interactive use. Such a channel activated system is described in U.S. Pat. No. 5,587,734 (Lauder et al.), the full disclosure of which is hereby incorporated by reference herein.

The user set-top box, or other upstream communication device, is pre-loaded with a small application program for permitting interactive service. When the user submits a request for interactive service, the application program is accessed for communications with the operations manager 141. The application program has been configured by the system operator to communicate over a designated path with the operations manager. In certain embodiments, the application program communicates a set top box type to the operations manager. For example, the application program will identify the set top box as either a cable set top box, an IP set top box, or other set top box type. Thus, the operations manager 141 knows the type of distribution network associated with the set top box. If the application program knows its address for receiving interactive video, the address is sent along with the request for interactive service to the operations manager. If the application program needs to learn its address, it asks the operations manager or another settop box application to provide the address. Then the address can be sent along with the request for interactive service.

The operations manager 141 receives the request for interactive service and establishes an interactive session using the received address for addressing the digital decoder. The operations manager 141 may also receive the set top type. The set top type allows the operations manager to determine whether the return signal will be sent to the received address on an rf frequency or not.

In accordance with a preferred embodiment, the address may be an IP address. In a Telephony IP distribution network, the IP address is associated directly with the digital decoder and all communications between the interactive information platform and the digital decoder can be conducted using this IP address. In contrast, in a cable network, an IP address may be used to identify a digital multiplexer (digimux) within the interactive information platform that multiplexes multiple information content streams for multiple sessions together and transmits the streams onto an rf cable channel. A digital multiplexor that has more than one output will have a different transport stream ID for each output. The outputs may be directed down separate cable trunks or may be different rf channels for sending down the same trunk. Since many digital decoders will be on a cable serviced by the digital multiplexor and more than one at a time may be receiving interactive service, the decoders will look for a television information stream identifier assigned to its interactive session. The operations manager 141 will inform the digital decoder of the television information stream identifier (i.e. program number or virtual channel number), at the beginning of a session. In other embodiments, the television information stream identifier is a function of QAM configuration and is configured upon initialization of the QAM decoder within the set top box. When an MPEG Transport Stream is delivered to the set top box, the program identifier allows the digital decoder to locate and decode the stream containing the requested information content.

In other embodiments, the set top box sends the set top type to the operations manager. If the set top type identifies the set top box as residing in a cable distribution network, the operations manager can access the IP address for the digimux. Additionally, the operations manager will provide the set top box with a stream identifier, which is an indicator of the assigned rf channel for QAM decoding. If the set top type identifies the set top box as residing in an IP distribution network, the operations manager uses the received address for addressing the digital decoder. In such an embodiment, the set top boxes may not have permanently assigned IP addresses. The operations manager 141 will use the received address.

The operations manager 141 selects a processor (142a for example) to run a process assigned to the interactive session for the digital decoder. The operations manager 141 passes the request for interactive information content including the address associated with the digital decoder and a stream identifier for labeling the desired information content. Each processor may be assigned one or more interactive sessions and is capable of processing multiple sessions simultaneously. Either the operations manager 141 or the assigned processor 142 provides information to the digital decoder so that upstream communications can be sent to the assigned process on the assigned processor 142. Once the operations manager 141 has established the interactive session between the digital decoder 111 and the assigned processor 142, communications pass directly from the digital decoder to the assigned processor without intervention of the operations manager 141.

The assigned processor 142 receives the request for interactive service and satisfies the request (or seeks reassignment to a more suitable processor). If information content needs to be retrieved, the information content is obtained either from local storage (not shown), an external storage location 150, or from a request for content through an Internet gateway or directly to a server on the Internet. Once the content is retrieved and directed to the processor 142, the processor renders the interactive information content (if necessary) and then encodes the content. For example, if the requested interactive information content is a video game, the video game's data will be rendered by a graphics processor/process associated with the processor 142. The processor 142 may also employ standard browser plug-ins or other applications in the rendering process, such as, Flash, ShockWave, QuickTime, RealPlayer, Windows Media Player, and others. The rendered data will then be encoded using an encoder such as an MPEG encoder. As previously mentioned, the media format that is selected is compatible with the requesting digital decoder 111. Preferably, a standard such as MPEG is established so that all data can be encoded to that standard regardless of the requesting digital decoder and on which of the disparate television distribution networks it resides. The sessions processor 142 will then attach the address associated with the digital decoder and the stream identifier to the rendered and encoded television information stream. The stream may include both video and audio content. The sessions processor will direct the addressed television information stream onto the communication link for delivery to the distribution equipment associated with the television distribution system (110, 120, or 130) of the requesting user. The distribution equipment puts the information into a form for transport on the appropriate distribution system to the user's digital decoder 111. The addressed information content can advantageously be directed onto the television distribution network of the addressed digital decoder, from among a plurality of disparate television distribution networks in communication with the interactive information platform. Upon receiving an addressed television information stream, the digital decoder 111 uses its standard functionality to demodulate and/or strip away packet headers from the television information stream. The video is decoded and displayed on the television. Thus, in accordance with embodiments of the present invention, the digital decoder need perform no rendering. The main functions performed by the digital decoder are demodulation and decoding of the video signal, just as it does for non-interactive video. Upstream signals entered by the user go to the assigned processor so that the user may interact with the displayed video to alter the received video content thus enabling interactive television.

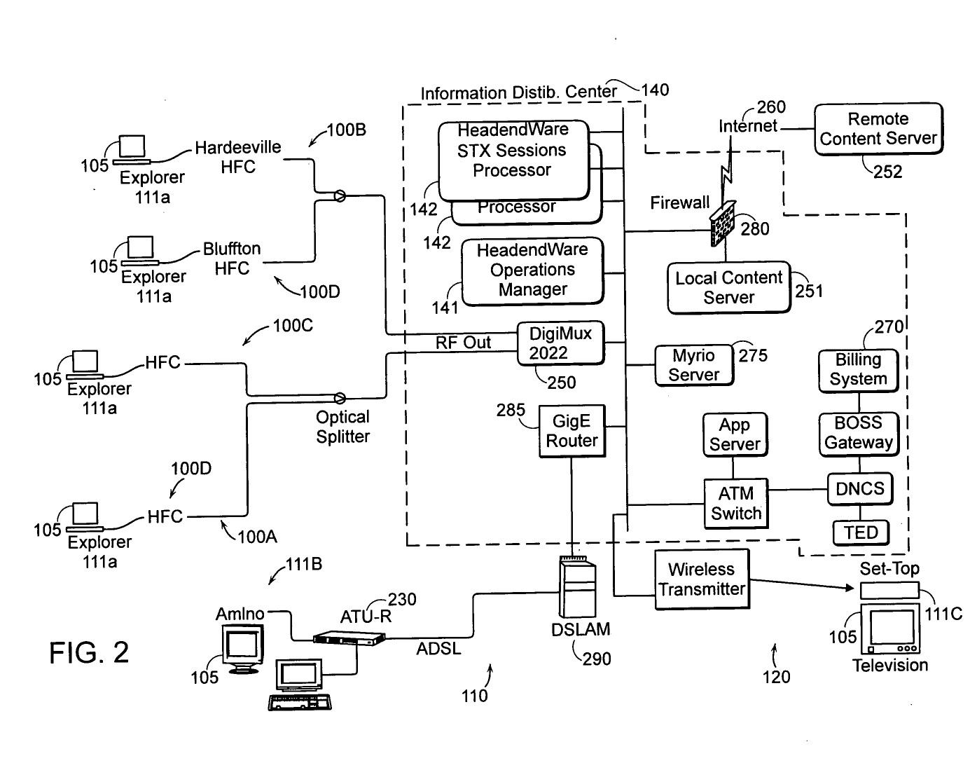

FIG. 2 is a more detailed diagram of the system and environment for providing interactive information content from an interactive information platform shared by a plurality of disparate distribution networks. In this embodiment, an IP telephony distribution network 110 capable of providing television content, a plurality of cable television distribution networks 100A, 100B, 100C, 100D and a wireless distribution network 120 are shown. Each of the distribution networks includes a plurality of digital decoders 111 for receiving and decoding television information signals. These signals may include interactive information content or conventional television information content. As used herein, television information content refers to broadcast television that is available for distribution to all of the users on a distribution network. To the extent a distribution network requires a modem, it may be included within the digital decoder or external to it. In the IP telephony network 110, a DSL modem 230 is shown external from the digital decoder 111b. The digital data received by the DSL modem 230 is passed to the home digital decoder 111b that decodes the information content and displays the information content on the associated television/monitor 105.

Digital decoders can be simply configured for interactive service by installing a small client application. Typically, the client application can be downloaded through its respective television distribution network. The client application is executed on the digital decoder for managing an interactive session in response to a user request that is made through a user input device (not shown). This client application can be installed into the memory of a standard digital decoder, such as, those made by Scientific Atlanta, Motorola® or Amino. The digital decoder 111 using the client application forwards the request for an interactive session to the interactive information platform 140 along with an address for responding and the set top box type. In response, the operation manager 141 assigns a sessions processor 142 and provides the address and the set top box type to the sessions processor.

If a choice of interactive downstream channels is available, the interactive information platform 140 will instruct the digital decoder as to which channel to tune to, in order to find its stream. The digital decoder receives the instructions of where to tune in the response to the original request. Typically, the original request is sent as a UDP datagram, and the interactive information platform sends a UDP datagram as a response. The digital decoder typically has the capability to receive UDP datagrams.

The interactive session is then conducted through the sessions processor 142 where the sessions processor 142 communicates with the digital decoder 111 and provides the interactive information content. The interactive information content is responsive to upstream signals entered by the user through a remote control or keyboard or other suitable input device. The session is terminated by the client program on the digital decoder 111 either after a predetermined timeout period or upon an active termination of the session by the user. The client program communicates requests through IP sockets via the upstream path to the interactive information platform 140. In the present embodiment, each request is wrapped in UDP or TCP packets.

The operations manager 141 is a module that includes a processor that controls the sessions processors 142. The operations manager 141 receives user session requests that include an associated address or a set top box type associated with the digital decoder for an interactive session, determines if sufficient resources are available to host the requested interactive session, and routes the session to an appropriate sessions processor. The sessions processor can reassign a processor based upon the available bandwidth and requirements of an interactive session. The operations manager also initiates and approves termination of each interactive session.

In one embodiment, the sessions processor 142 is part of a module that contains two processors, such as, Intel Pentium® processors. The sessions processor communicates through a communications link, such as an Ethernet connection, with the digital multiplexor 250, the operations manager 141, the local content servers 251 and with servers 252 within the internet 260 via an internet gateway. The sessions processor 142 may run a browser session on behalf of a requesting user, which is used to render the interactive information content. With other interactive information content, other programs or hardware may be employed for rendering. The data that forms the interactive information content once rendered is compressed using a standard MPEG scheme, such as video and audio by the sessions processor. The sessions processor includes the address associated with the requesting digital decoder with the rendered and encoded interactive information content. In one embodiment, the address is an IP address. The IP address may be for the set top box or for a digimux that forwards the interactive information content to the digital decoder. The sessions processor only needs the address and PID. It does not care on which television distribution network the digital decoder resides. The streams from multiple sessions processors are output onto the communication link. Those streams bound for the cable television distribution network are routed by their IP address to the proper digital multiplexor 250 and its output that will be sent on a signal and cable to be received by the digital decoder involved in the session. Streams bound for the telephone network are routed by router 285 onto the distribution network using the IP address associated with the digital decoder in the telephone network.

After the session has been negotiated with the operations manager 141, the operations manager 141 provides the digital decoder 1 11 with information regarding the interactive session. For example, in a cable distribution system 100, the digital decoder 111a is provided with information instructing the digital decoder 111a to decode a particular stream number (PID) within a plurality of streams. In the cable distribution system, the sessions processor directs all communications for a session to the digital multiplexer that is associated with the digital decoder using an IP address associated with one of the digital multiplexer's outputs. In certain embodiments, there may be a plurality of digital multiplexers each having different IP addresses. In a digital telephony system, digital decoder 111b is provided with information regarding the assigned processor 142 and is set to listen for specifically addressed IP packets directed from the sessions processor 142.

The interactive information platform 140 includes two or more session processors 142 for retrieving, rendering, and encoding interactive information content associated with an interactive session and an operations manager processor 141 for receiving requests from users initiating interactive sessions, and directing requests for content to the interactive sessions processors 141.

The interactive information platform 140 further includes a billing system 270, a local content server 251, and a connection to the internet 260 that are shared amongst all of the distribution networks although each computing device may be on a separate physical network. Also included is a server 275 for general television information content. The television information content does not require an interactive session and is distributed to all users of the distribution network In one embodiment, the server 275 is a server made by Myrio Corporation Inc. The Myrio server produces television over IP signals that are provided to each of the distribution networks. On the communication link of the interactive information platform 140, the interactive information content and television information content will be transmitted as IP packets. The disparate television distribution networks are all able to receive IP packets directed to the respective network and distribute the television information content to the user associated with that content. Each network has distribution equipment that puts the content into a form for transport to the digital decoder of the user.

For the telephony IP network 110, the distribution equipment includes a DSLAM 290 or digital subscriber line multiplexor. The DSLAM 290 connects the individual subscriber lines to the interactive information platform. The DSLAM 290 receives IP packets that are addressed to specific IP addresses of digital decoders and demultiplexes the interactive information content by IP address. The DSLAM 290 then distributes the interactive information content by IP address along the individual telephony lines in a unicast fashion. The interactive information content is sent to a DSL modem 230 which forward the content to the requesting digital decoder 111b.

As shown, there is a gigabit Ethernet (GigE) router 285 that is coupled to the communication link of the interactive information platform. This router is physically coupled to at least a portion of the physical communication link, and allows for the distribution of data between different logical communication networks such as the billing network, which contains billing system 270, the local content network, which contains local content server 251, and the IP television network, which contains IP television server 275. The GigE router also routes the interactive information content to different DSLAMs. For example, the telephony network 110 may include a plurality of DSLAMs and the GigE router can route the interactive information content to the DSLAM that is associated with the appropriate digital decoder. The GigE router receives in IP packets from the physical communication link and directs the IP packets to the proper network.

For the cable television distribution network, the digital multiplexor 250 is a module that contains a processor for receiving addressed IP packets from multiple sessions processors. The digital multiplexor strips away the IP headers leaving MPEG video and audio stream data. These MPEG video and audio streams from a plurality of sessions processors are multiplexed into an MPEG transport stream. Each digital decoder knows the PID of its assigned MPEG video and audio stream. The digital multiplexor also performs QAM generation and upconversion. After consolidating and quadrature amplitude modulating the signal, the signal is upconverted to a selected cable channel in the 54-860 MHz range. The digital multiplexor outputs this radio frequency signal at a level suitable for injection into a cable channel. Each digital decoder that is part of an interactive session receives the MPEG transport stream, demodulates the MPEG transport stream, and then decodes the MPEG audio and video stream having the PID number for the session.

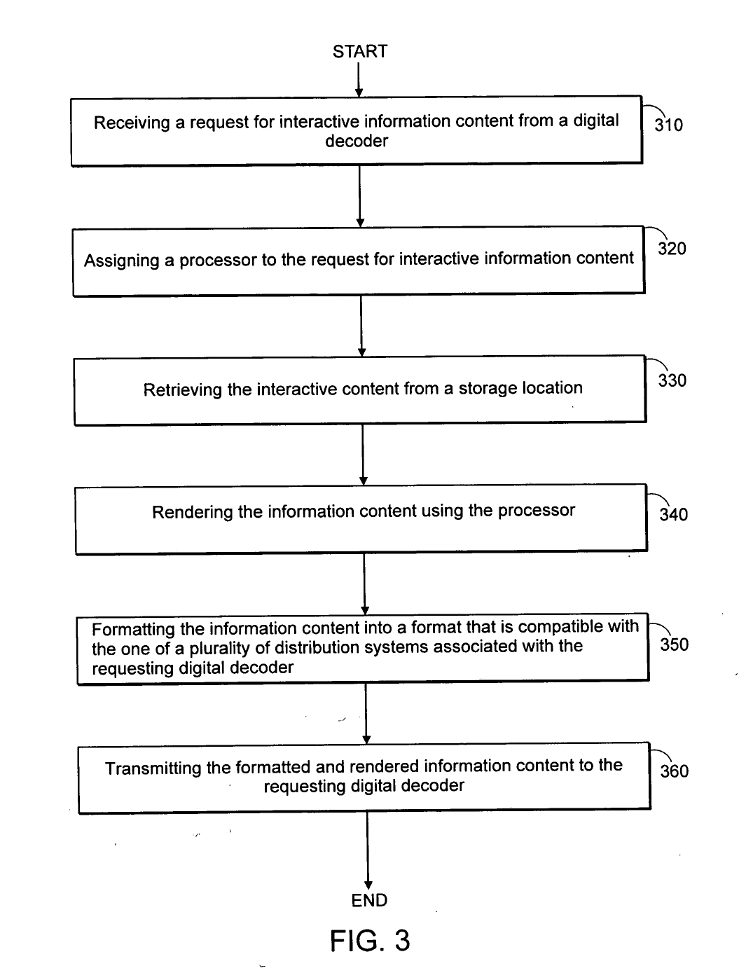

FIG. 3 is a flow chart that shows the steps that are employed in distributing information content to requesting users in a plurality of disparate distribution networks. The interactive information platform receives a request for interactive information content from a user. The interactive information platform assigns a processor to the request for interactive content 320. The sessions processor retrieves the interactive information content from a storage location 330. The interactive content may be stored locally with the interactive information platform or remotely in the Internet or on a server in another network. The sessions processor renders the interactive information content 340. Rendering is achieved by processing the interactive information content for display on a television. The interactive information content is also placed into the proper media format for the requesting digital decoder. The interactive information content may be compressed and placed into one of the plurality of MPEG media formats. Addressed information content is directed to distribution equipment on the television distribution network of the requesting digital decoder. The distribution equipment processes the rendered and formatted information for transport on the respective television distribution network to the digital decoder of the requesting user 360.

The foregoing description of embodiments of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. An interactive information platform comprising:
a plurality of assignable sessions processors arranged to responsively provide information content encoded into a format capable of being decoded by a decoder associated with a television;
an operation manager receiving requests for information content from one or more television user in any of a plurality of disparate television distribution networks and assigning one of the session processors to establish an interactive session for each requesting user; and
a communications link between the assignable processors and the operation manager, from which the information content can be sent to the television associated with the requesting user on any of the plurality of disparate television distribution networks.

2. The interactive information platform according to claim 1, wherein at least one of the session processors is capable of controlling a plurality of sessions.

3. An interactive television system having an interactive information platform according to claim 1 and further comprising:
a digital subscriber line multiplexor for demultiplexing information content associated with a plurality of sessions wherein each session is associated with a separate television and distributing through a telephone line the requested information content to the television associated with the session.

4. An interactive television system having an interactive information platform according to claim 1 and further comprising a router connected to the communication link for directing information content associated with a plurality of sessions through a telephone network.

5. An interactive television system having an interactive information platform according to claim 1 and further comprising a digital multiplexor for multiplexing information content from a plurality of sessions wherein each session is associated with a separate digital decoder in a cable television network

6. The interactive television system of claim 5 wherein multiplexing further comprises creating a radio frequency quadrature amplitude modulated signal.

7. A method of providing interactive television content from an interactive information platform to one of a plurality of digital decoders residing in one of a plurality of disparate television distribution networks, each digital decoder associated with a television, the method comprising:
receiving a request for interactive information content from a user associated with a television;
assigning a processor to the request for interactive information content;
retrieving the information content from a storage location;
rendering the information content using the processor;
formatting the information content into a format that is compatible with the digital decoders on the plurality of television distribution networks; and
transmitting the formatted and rendered information content to the requesting digital decoder.

8. The method according to claim 7 wherein formatting includes compressing the information content into a format that is compatible with the digital decoder.

9. The method according to claim 8, wherein the format is an MPEG format.

10. The method according to claim 7, wherein each distribution network has a different transmission format.

11. The method according to claim 7, wherein one of the television distribution networks is a cable television network and a second one of the television distribution networks is a telephone network.

12. The method according to claim 7, wherein one of the television distribution networks is a telephone network and a second one of the television distribution networks is a wireless network.

13. The method according to claim 7, wherein one of the television distribution networks is a wireless network and a second one of the television distribution networks is a cable television network.

14. The method according to claim 7, wherein one of the television distribution networks is a cable television network carrying television signals using an IP protocol and a second one of the television distribution networks is a telephone network using an IP protocol.

15. The method according to claim 7 wherein the interactive information content is a video game.

16. The method according to claim 7, wherein the interactive information content is a movie.

17. The method according to claim 7, wherein the formatted and rendered interactive information content is multiplexed with other formatted and rendered interactive information content prior to being transmitted through a distribution network.

18. The method according to claim 17, wherein the information content is demultiplexed using a digital subscriber line multiplexor.

19. The method according to claim 17 wherein the information content is multiplexed using a digital multiplexor that performs quadrature amplitude multiplexing.

20. The method according to claim 17 wherein the information content is multiplexed using either a digital multiplexor for distribution to a digital decoder in a cable television network or demultiplexed by a digital subscriber line multiplexor for distribution to a digital decoder in a telephone network.

21. An interactive television system for managing interactive sessions over a plurality of disparate television distribution networks comprising:
a plurality of assignable interactive processes that provide television information content in response to television user interaction;
a communication link that carries said television information content;
first television distribution equipment in communication with a first of said disparate television distribution networks and said communication link so as to distribute television information content to those of said television users on said first of said television distribution networks; and
second television distribution equipment in communication with a second of said television distribution networks and said communication link so as to distribute television information content to those of said television users on said second of said television distribution networks.

22. The interactive television system of claim 21 wherein said first television distribution equipment comprises a digital multiplexor for multiplexing television information content from a plurality of interactive processes sessions onto rf carrier signals for distribution over a cable television network.

23. The interactive television system of claim 22 wherein said second television distribution equipment comprises a router for directing television information content over an IP network towards a television user associated with the content.

24. The interactive television system of claim 23 wherein the IP network is a telephone system.

25. The interactive television system of claim 24 wherein the IP network is a wireless telephone system.

26. The interactive television system of claim 25 wherein the IP network is a cable television network.

27. The interactive television system of claim 23 wherein said second television distribution equipment further includes a digital subscriber line multiplexor for receiving information content from the router and demultiplexing the content to send television information content to the user associated with the content.

28. The interactive television system of claim 21 wherein said communication link includes an Ethernet connection.

29. The interactive information platform according to claim 1, wherein the operations manager receives an address from a digital decoder and provides the address to the assigned sessions processor for addressing the information content.

30. The interactive information platform according to claim 3, wherein the digital subscriber line multiplexor demultiplexes based upon an address provided by a digital decoder and the information content is forwarded to the digital decoder.

31. The interactive information platform according to claim 1, further comprising:
a digital multiplexor for multiplexing information content streams from a plurality of sessions;
wherein the operations manager receives an address from a digital decoder and provides the address to the assigned sessions processor for addressing the information content;
wherein if the digital decoder is in a cable television network the address provided by the digital decoder is for the digital multiplexor; and
wherein an identifier is provided to the digital decoder identifying the information content stream to be decoded.

32. An interactive television system for managing interactive sessions over a plurality of disparate television distribution networks comprising:
a plurality of assignable interactive processes that address television information content to a requestor on one of the disparate television distribution networks and maintain an interactive session with the requestor;
a communication link that carries said addressed television information content for delivery onto the television distribution network of the requester.
